(19) United States
(12) Patent Application Publication
(10) Pub. No.: US 2004/0208718 A1
(43) Pub. Date: Oct. 21, 2004

(54) Machine for processing electrodes formed on a plate-like workpiece

(76) Inventors: Kazuhisa Arai, Tokyo (JP); Takashi Mori, Tokyo (JP); Hideyuki Sandoh, Tokyo (JP); Shinichi Namioka, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/820,853

(22) Filed: Apr. 9, 2004

(30) Foreign Application Priority Data
Apr. 15, 2003 (JP) 2003-110536

(51) Int. Cl. B23C 1/14; B23C 3/13

(52) U.S. Cl. 409/139; 409/166; 409/167

(57) ABSTRACT

A machine for making a plurality of electrodes projecting from the front surface of a plate-like workpiece uniform in height, comprising a chuck table having a placing surface for placing the plate-like workpiece, which can be moved between a workpiece take-in/take-out area and a processing area, a chuck table moving unit for moving the chuck table between the workpiece take-in/take-out area and the processing area, a cutting unit having a cutting tool for cutting a plurality of electrodes projecting from the front surface of the plate-like workpiece arranged in the processing area and held on the chuck table to make them uniform in height, a cutting unit feed mechanism for moving the cutting unit in a direction perpendicular to the placing surface of the chuck table, a take-in means for carrying the plate-like workpiece before processing to the chuck table positioned in the workpiece take-in/take-out area; and a take-out means for taking out the plate-like workpiece after processing held on the chuck table positioned in the workpiece take-in/take-out area.

### FIELD OF THE INVENTION

The present invention relates to a processing machine for making a plurality of electrodes projecting from the front surface of a plate-like workpiece such as a semiconductor chip uniform in height.

### DESCRIPTION OF THE PRIOR ART

A semiconductor wafer having a plurality of semiconductor chips are divided into individual semiconductor chips by a dicer or the like, and the obtained semiconductor chips are widely used in electric appliances such as cellular phones and personal computers.

To make electric appliances lightweight and compact, a semiconductor chip called “flip chip” having bumps as high as 50 to 100 μm which are formed on the electrodes of the semiconductor chip and directly bonded to electrodes formed on an implemented substrate has been developed and put to practical use. A technology for mounting a plurality of semiconductor chips on a substrate called “interposer” has also been developed and put to practical use for downsizing.

Since in the above technologies, a plurality of protuberant bumps (electrodes) are formed on a front surfaces of the substrates of semiconductor chips and the substrates are bonded to each other through the protuberant bumps (electrodes), the protuberant bumps (electrodes) must be made uniform in height. To realize this, grinding is generally used. However, when the bumps (electrodes) are ground, burrs are produced if the bumps (electrodes) are made of a sticky metal such as gold, thereby causing a problem that a short circuit occurs between adjacent bumps (electrodes).

As a technology for forming a plurality of protuberant bumps (electrodes) on the front surfaces of the substrates of semiconductor chips, there is a stud bump forming method in which a ball is formed by heat-melting the tip end of a wire such as a gold wire, press-bonded by heating and ultraviolet waves onto the electrodes of a semiconductor chip and cut off at its base. It is difficult to polish bumps formed by this stud bump forming method because needle-like whiskers are formed by cutting the base of the ball press-bonded under heating, and the bumps are made uniform in height by pressing a heated plate against them. This technology is disclosed, for example, by an unexamined published Japanese patent application JP-A 2001-53097.

When the bumps are made uniform in height by pressing the heated plate against them, however, the heads of the bumps are crushed, thereby producing a problem that a short circuit is caused between adjacent bumps. To solve this problem, in the invention disclosed by the above publication, a step of removing the tip end portions of the bumps is added.

### SUMMARY OF THE INVENTION

It is an object of the present invention to provide a processing machine capable of easily making a plurality of electrodes projecting from the front surface of a plate-like workpiece uniform in height, without causing a short circuit occurs between adjacent electrodes.

According to the present invention, the above object is attained by a machine for processing electrodes formed on a plate-like workpiece to make the electrodes projecting from the front surface of the plate-like workpiece uniform in height, comprising:

a chuck table having a placing surface for placing the plate-like workpiece, which can be moved between a workpiece take-in/take-out area and a processing area;

a chuck table moving unit for moving the chuck table between the workpiece take-in/take-out area and the processing area;

a cutting unit having a cutting tool for cutting a plurality of electrodes projecting from the front surface of the plate-like workpiece arranged in the processing area and held on the chuck table to make them uniform in height;

a cutting unit feed mechanism for moving the cutting unit in a direction perpendicular to the placing surface of the chuck table;

a take-in means for taking in the plate-like workpiece before processing to the chuck table positioned in the workpiece take-in/take-out area; and

a take-out means for taking out the plate-like workpiece after processing held on the chuck table positioned in the workpiece take-in/take-out area.

Preferably, the above processing machine comprises a cassette placing portion for placing a cassette storing a plurality of plate-like workpieces, a workpiece conveying means for taking out the plate-like workpiece before processing from a cassette placed on the cassette placing portion, and a workpiece temporary storage portion for temporarily storing the plate-like workpiece carried by the workpiece conveying means, and the plate-like workpiece carried to the workpiece temporary storage portion is conveyed onto the chuck table positioned in the workpiece take-in/take-out area by the take-in means.

More preferably, the above processing machine further comprises a cleaning means for cleaning the plate-like workpiece after processing, the plate-like workpiece after processing held on the chuck table positioned in the workpiece take-in/take-out area is carried to the cleaning means by the take-out means, and the plate-like workpiece after processing cleaned by the cleaning means is stored in a cassette placed on the cassette placing portion by the workpiece conveying means.

Much more preferably, the processing machine further comprises a processing fluid supply means for supplying a processing fluid toward the plate-like workpiece held on the chuck table in the processing area, and the processing fluid supply means supplies ionized air.

### BRIEF DESCRIPTION OF THE DRAWINGS

FIG. 1 is a perspective view of a processing machine constituted according to an embodiment of the present invention;

FIG. 2 is a perspective view of an example of a cutting tool constituting a cutting unit provided in the processing machine shown in FIG. 1;

FIG. 3 is an enlarged perspective view of the substantial section of the cutting tool shown in FIG. 2 when seen from the under surface side;

FIG. 4 is an enlarged perspective view of the substantial section of another example of the cutting tool;

FIG. 5 is an enlarged perspective view of the substantial section of still another example of the cutting tool;

FIG. 6 is a perspective view of a further example of the cutting tool mounted on the cutting unit;

FIG. 7 is a perspective view of a chuck table mechanism and a chuck table moving unit provided in the processing machine shown in FIG. 1;

FIG. 8 is a plan view of a semiconductor wafer as a plate-like workpiece;

FIGS. 9(a), 9(b) and 9(c) are diagrams for explaining a stud bump forming method for forming stud bumps (electrodes) on a plurality of semiconductor chips formed in the semiconductor wafer shown in FIG. 8;

FIG. 10 is a perspective view of semiconductor chips as plate-like workpieces supported on an annular frame;

FIG. 11 is a perspective view of semiconductor chips as plate-like workpieces supported on a substrate;

FIG. 12 is a diagram showing the relationship between the semiconductor wafer held on the chuck table and the cutting tool; and

FIG. 13 is a diagram showing a state of bumps (electrodes) formed on the semiconductor chip being processed by the processing machine shown in FIG. 1.

### DETAILED DESCRIPTION OF THE PREFERRED EMBODIMENTS

A machine for processing electrodes formed on a plate-like workpiece according to preferred embodiments of the present invention will be described in detail hereinbelow with reference to the accompanying drawings.

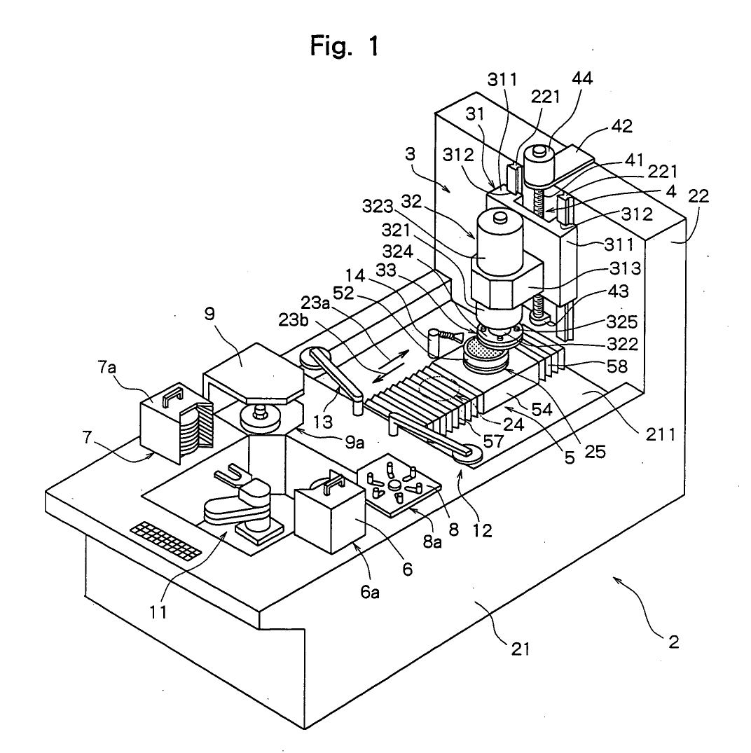

FIG. 1 is a perspective view of a processing machine constituted according to the present invention.

The processing machine in the illustrated embodiment has a housing denoted as a whole by 2. The housing 2 comprises a rectangular parallelepiped main portion 21 extending in an elongated shape and an upright wall 22 extending upward and substantially vertically from the rear end portion (right upper end in FIG. 1) of the main potion 21. A pair of guide rails 221 and 221 extending in the vertical direction are installed on the front side of the upright wall 22. A cutting unit 3 is mounted on the pair of guide rails 221 and 221 in such a manner that it can move in the vertical direction.

The cutting unit 3 has a movable base 31 and a spindle unit 32 mounted on this movable base 31. The movable base 31 is provided with a pair of legs 311 and 311 extending in the vertical direction on both sides of the rear side and a pair of to-be-guided grooves 312 and 312 to be slidably engaged with the pair of guide rails 221 and 221 are formed in the pair of legs 311 and 311. A support portion 313 projecting forward is installed on the front side of the movable base 31 slidably mounted on the pair of guide rails 221 and 221 provided on the upright wall 22. The spindle unit 32 is fitted onto the support portion 313.

The spindle unit 32 comprises a spindle housing 321 fitted in the support portion 313, a rotary spindle 322 rotatably disposed in the spindle housing 321, and a servo motor 323 as a drive source for rotary-driving the rotary spindle 322. The lower end portion of the rotary spindle 322 is projected downward beyond the lower end of the spindle housing 321, and a disk-like tool attachment member 324 is arranged to the lower end portion. A plurality of bolt insertion holes (not shown) are formed in the tool attachment member 324 at predetermined intervals in the circumferential direction. A cutting tool 33 is mounted on the under surface of the tool attachment member 324.

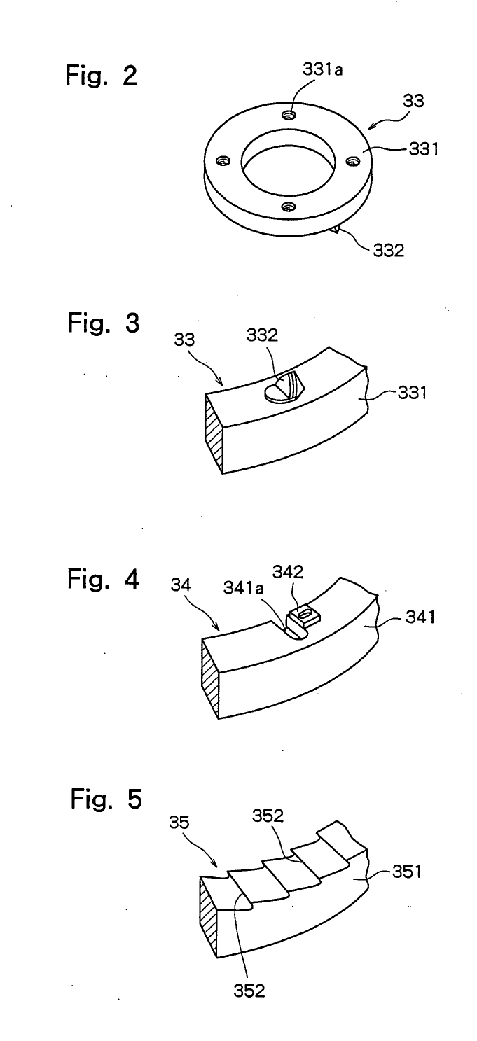

An example of the cutting tool 33 will be described with reference to FIG. 2 and FIG. 3.

The cutting tool 33 shown in FIG. 2 and FIG. 3 is constructed by a ring-like base 331 and a cutting blade 332 attached to at least one position of one surface side of the base 331. The base 331 is made of an aluminum alloy or the like, and a plurality of blind screw holes 331a extending from one surface side to the other surface side are formed in the base 331. The cutting blade 332 is installed upright from the base 331, has an acute-angled end and is composed of a diamond cutting tool, for example. The thus constituted cutting tool 33 is mounted on the tool attachment member 324 by positioning it on the under surface of the tool attachment member 324 fixed to the lower end portion of the rotary spindle 322 in such a manner that one side having the cutting blade 332 of the cutting tool 33 faces down and then by screwing fastening bolts 325 into the blind screw holes 331a formed in the base 331 via through holes formed in the tool attachment member 324.

Other examples of the cutting tool will be described with reference to FIGS. 4 to 6.

A cutting tool 34 shown in FIG. 4 is constructed by forming at least one depression 341a on one surface side of a ring-like base 341 and mounting a cutting blade 342 such as a rectangular super steel cutting tool or diamond cutting tool having a thickness of about several millimeters in proximity to the depression 341a.

A cutting tool 35 shown in FIG. 5 is constituted such that a ring-like base 351 is made of tool steel such as super steel alloy, and at least one cutting blade 352 (plural in the embodiment shown in FIG. 5) acute-angled toward the rotation direction is formed at at least one position of one surface side of the base 351. Diamond chips may be provided on the surface of the cutting blade 352.

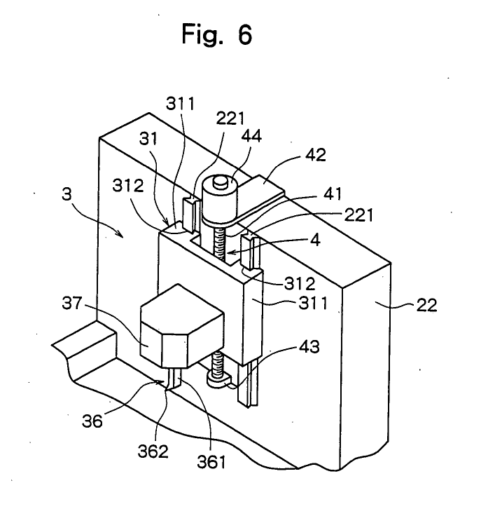

A cutting tool 36 shown in FIG. 6 has a cutting blade 362 made of diamond or the like at the tip end of its tool body 361 which is formed like a rod and made of tool steel such as super steel alloy. When the cutting tool 36 shown in FIG. 6 is used, the tool attachment member 37 is directly mounted on the movable base 31 constituting the cutting unit 3, and the tool body 361 is attached to the tool attachment member 37.

Returning to FIG. 1, the processing machine in the illustrated embodiment has a cutting unit feed mechanism 4 for moving the above cutting unit 3 along the pair of guide rails 221 and 221 in the vertical direction (direction perpendicular to the placing surface of a chuck table which will be described later). This cutting unit feed mechanism 4 has a male screw rod 41 extending substantially vertically and arranged on the front side of the upright wall 22. The upper end portion and lower end portion of this male screw rod 41 are rotatably supported by bearing members 42 and 43 mounted on the upright wall 22, respectively. A pulse motor 44 as a drive source for rotary-driving the male screw rod 41 is mounted on the upper bearing member 42, and the output shaft of this pulse motor is coupled to the male screw rod 41. A coupling portion (not shown) projecting backward from the center portion in the width direction of the rear side of the movable base 31 is formed on the rear side thereof, a threaded screw hole extending in the vertical direction is formed in the coupling portion, and the above male screw rod 41 is screwed into the threaded screw hole. Therefore, when the pulse motor 44 rotates in a normal direction, the movable base 31, that is, the cutting unit 3 is lowered, that is, advanced, while when the pulse motor 44 rotates in a reverse direction, the movable base 31, that is, the cutting unit 3 is moved up, that is, retreated.

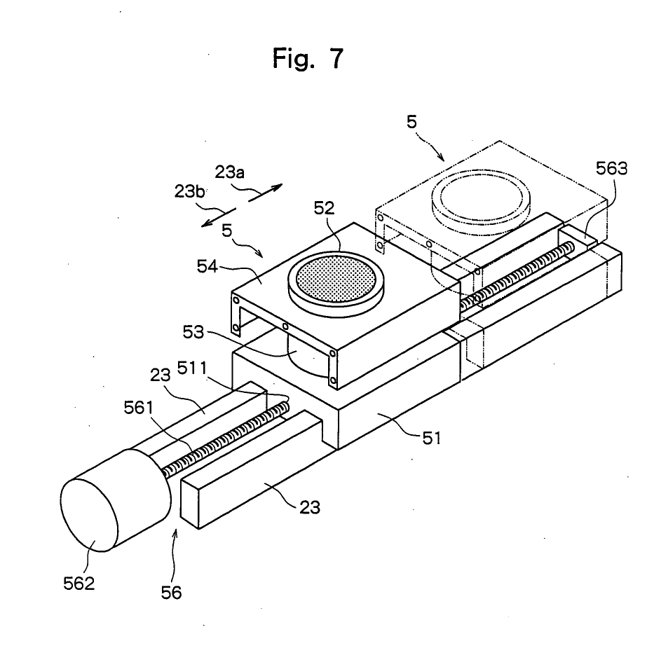

With reference to FIG. 1 and FIG. 7, a substantially rectangular working portion 211 is formed on the rear half of the main portion 21 of the housing 2. A chuck table mechanism 5 is arranged on this working portion 211. The chuck table mechanism 5 comprises a support base 51 and a disk-like chuck table 52 arranged on this support base 51 in such a manner that it can rotate on its rotation center axis extending substantially vertically. The support base 51 is slidably placed on a pair of guide rails 23 and 23 extending in directions shown by arrows 23a and 23b which are forward and backward directions (directions perpendicular to the front side of the upright wall 22) on the above working portion 211 and moved between a workpiece take-in/take-out area 24 (position shown by the solid line in FIG. 7) shown in FIG. 1 and a processing area 25 (position shown by the two-dot chain line in FIG. 7) that is opposed to the cutting tool 33 constituting the above spindle unit 32 by a chuck table moving unit 56 which will be described later.

The above chuck table 52 has a placing surface for placing a workpiece at the top and is rotatably supported on the above support base 51. This chuck table 52 is rotated by a servo motor 53 coupled to a rotary shaft (not shown) mounted onto the under surface thereof. The chuck table 52 is made of a suitable porous material such as porous ceramics and connected to a suction means that is not shown. Therefore, a workpiece placed on the placing surface is suction-held by communicating the chuck table 52 with the suction means (not shown) selectively. The illustrated chuck table mechanism 5 comprises a cover member 54 (see FIG. 1) having a hole into which the chuck table 52 is inserted, which covers the above support base 51 etc., and can move together with the support base 51.

With reference to FIG. 7, the processing machine in the illustrated embodiment comprises the chuck table moving unit 56 for moving the above chuck table mechanism 5 along the pair of guide rails 23 and 23 in the directions shown by the arrows 23a and 23b. The chuck table moving unit 56 has a male screw rod 561 arranged between the guide rails 23 and 23 and extending in parallel to the pair of guide rails 23 and 23 and a servo motor 562 for rotary-driving the male screw rod 561. The male screw rod 561 is screwed into a screw hole 511 formed in the above support base 51 and rotatably supported by a bearing member 563 whose ends are coupled to the pair of guide rails 23 and 23. The drive shaft of the servo motor 562 is coupled to the end of the male screw rod 561. Therefore, when the servo motor 562 rotates in a normal direction, the support base 51, that is, the chuck table mechanism 5 is moved in the direction shown by the arrow 23a, while when the servo motor 562 rotates in a reverse direction, the support base 51, that is, the chuck table mechanism 5 is moved in the direction shown by the arrow 23b. The chuck table mechanism 5 which is moved in the directions shown by the arrows 23a and 23b is selectively brought to a position in the workpiece take-in/take-out area shown by the solid line in FIG. 7 or the processing area shown by the two-dot chain line. The chuck table mechanism 5 is reciprocatingly moved in the directions shown by the arrows 23a and 23b over a predetermined distance in the processing area.

Returning to FIG. 1, bellow means 57 and 58 which have an inverted channel-like cross section and cover the pair of guide rails 23 and 23, the male screw rod 561 and the servo motor 562 as shown in FIG. 1 are installed on both sides in the moving direction of the support base 51 constituting the above chuck table mechanism 5. The bellow means 57 and 58 may be made of a suitable material such as campus cloth. The front end of the bellow means 57 is fixed to the front wall of the working portion 211 and the rear end thereof is fixed to the front end of the cover member 54 of the chuck table mechanism 5. The front end of the bellow means 58 is fixed to the rear end of the cover member 54 of the chuck table mechanism 5 and the rear end thereof is fixed to the front side of the upright wall 22 of the housing 2. When the chuck table mechanism 5 is moved in the direction shown by the arrow 23a, the bellow means 57 is expanded and the bellow means 58 is contracted, while when the chuck table mechanism 5 is moved in the direction shown by the arrow 23b, the bellow means 57 is contracted and the bellow means 58 is expanded.

With reference to FIG. 1, a first cassette placing portion 6a, a second cassette placing portion 7a, a workpiece temporary storage portion 8a and a cleaning portion 9a are arranged on the front half of the main portion 21 of the housing 2. A first cassette 6 for storing a workpiece before processing is placed on the first cassette placing portion 6a, and a second cassette 7 for storing a workpiece after processing is placed on the second cassette placing portion 7a. A workpiece temporary storage means 8 for temporarily storing a workpiece before processing taken out from the first cassette 6 placed on the first cassette placing portion 6a is arranged on the above workpiece temporary storage portion 8a. A cleaning means 9 for cleaning a workpiece after processing is arranged on the cleaning portion 9a.

A workpiece conveying means 11 is arranged between the above first cassette placing portion 6a and the second cassette placing portion 7a, and carries a workpiece before processing stored in the first cassette 6 placed on the first cassette placing portion 6a to the workpiece temporary storage means 8 and a workpiece after processing cleaned by the cleaning means 9 to the second cassette 7 placed on the second cassette placing portion 7a. A workpiece take-in means 12 is arranged between the above workpiece temporary storage portion 8a and the workpiece take-in/take-out area 24, and carries a workpiece before processing placed on the workpiece temporary storage means 8 to the top of the chuck table 52 of the chuck table mechanism 5 positioned in the workpiece take-in/take-out area 24. A workpiece take-out means 13 is arranged between the workpiece take-in/take-out area 24 and the cleaning portion 9a, and carries a workpiece after processing placed on the chuck table 52 positioned in the workpiece take-in/take-out area 24 to the cleaning means 9. The processing machine in the illustrated embodiment comprises a nozzle 14 that is a processing fluid supply means for supplying a processing fluid toward a workpiece held on the chuck table 52 in the processing area 25 in the side portion of the processing area 25 in the main portion 21 of the housing 2. The processing fluid may be air, cutting water, mist or ionized air. Ionized air is preferred in order to prevent the generation of static electricity. Therefore, the nozzle 14 in the illustrated embodiment is connected to an ionized air supply means that is not shown.

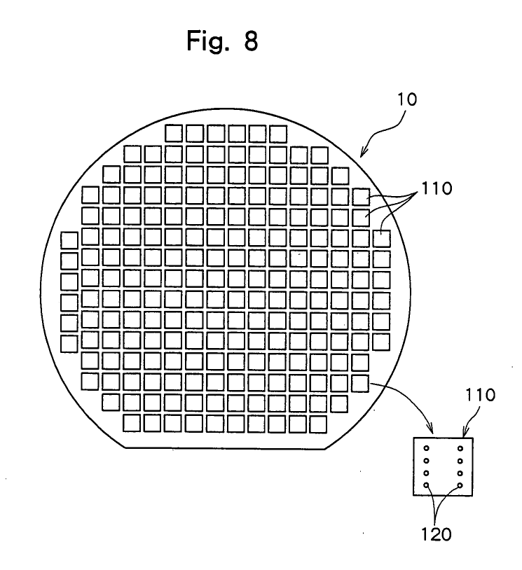

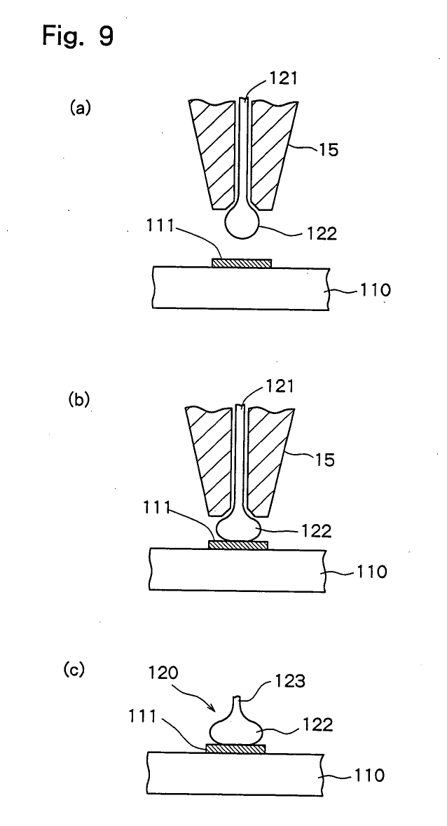

The workpiece before processing stored in the above first cassette 6 is a semiconductor wafer 10 having a plurality of semiconductor chips formed on the front surface in a lattice form as shown in FIG. 8. A plurality of stud bumps (electrodes) 120 are formed on the front surface of each of a plurality of semiconductor chips 110 formed in the semiconductor wafer 10. The stud bumps (electrodes) 120 are formed by the stud bump forming method, for example. That is, as shown in FIG. 9(a), the tip end of a gold wire 121 inserted into a capillary 15 is heat-molten by discharge with an electric torch to form a ball 122, and this ball 122 is press-bonded by heating and ultrasonic waves onto an electrode plate 111 made of, for example, aluminum formed on the semiconductor chip 110 as shown in FIG. 9(b), and cut off at its base. A plurality of stud bumps (electrodes) 120 thus formed have needle-like whiskers 123 and are not uniform in height as shown in FIG. 9(c).

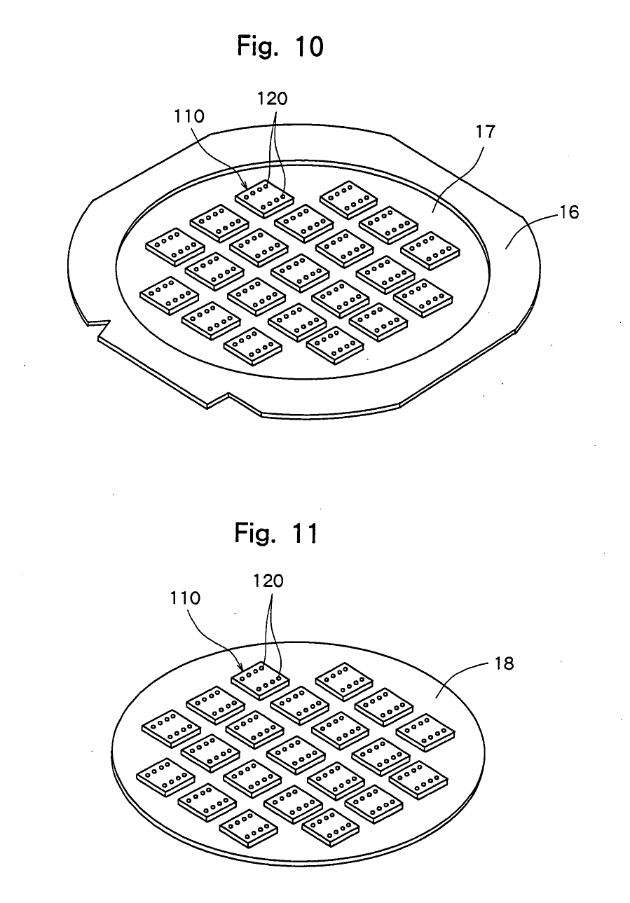

Other examples of the workpiece will be described with reference to FIG. 10 and FIG. 11.

The workpieces shown in FIG. 10 and FIG. 11 are semiconductor chips 110 obtained by individually dividing the above semiconductor wafer 10. FIG. 10 shows that a plurality of semiconductor chips 110 are affixed to a protective tape 17 mounted on an annular frame 16, and FIG. 11 shows that a plurality of semiconductor chips 110 are affixed to a substrate 18 by a double-sided adhesive tape, for example. The plurality of the above stud bumps (electrodes) 120 are formed on the front surfaces of the semiconductor chips 110.

The first cassette 6 that stores the above workpiece is placed on the first cassette placing portion 6a of the housing 2. When all the workpieces before processing stored in the first cassette 6 placed on the first cassette placing portion 6a are taken out, a new cassette 6 storing a plurality of workpieces before processing is manually placed on the first cassette placing portion 6a in place of the empty cassette 6. Meanwhile, when a predetermined number of workpieces after processing are carried into the second cassette 7 placed on the second cassette placing portion 7a of the housing 2, the second cassette 7 is manually taken out and an empty second cassette 7 is newly placed.

The processing machine in the illustrated embodiment is constituted as described above and its operation will be described with reference to FIG. 1 mainly. The semiconductor wafer 10 shown in FIG. 8 and FIGS. 9(a) to 9(c) is used as the workpiece, and the cutting tool 33 shown in FIG. 2 and FIG. 3 is used as the cutting tool.

The semiconductor wafer 10 which is a workpiece before processing stored in the first cassette 6 is carried to the workpiece temporary storage means 8 by the vertical and horizontal movements or advancing and retreating movements of the workpiece conveying means 11. After conducting center alignment here, the semiconductor wafer 10 placed on the workpiece temporary storage means 8 is then placed on the chuck table 52 of the chuck table mechanism 5 positioned in the workpiece take-in/take-out area 24 by the turning movement of the workpiece take-in means 12. The semiconductor wafer 10 placed on the chuck table 52 is suction-held on the chuck table 52 by a suction means that is not shown.

After the semiconductor wafer 10 is suction-held on the chuck table 52, the chuck table moving unit 56 (see FIG. 7) is activated to move the chuck table mechanism 5 in the direction shown by the arrow 23a and position it in the processing area 25 that is opposed to the cutting tool 33 attached to the rotary spindle 322 of the cutting unit 3. The cutting unit 3 is lowered while the chuck table 52 and the rotary spindle 322 are caused to rotate. As a result, the cutting blade 332 of the cutting tool 33 which rotates with the revolution of the rotary spindle 322 is brought into contact with the plurality of stud bumps (electrodes) 120 formed on the front surfaces of the semiconductor chips 110 of the semiconductor wafer 10 to cut away the top end portions of the stud bumps (electrodes) 120 gradually.

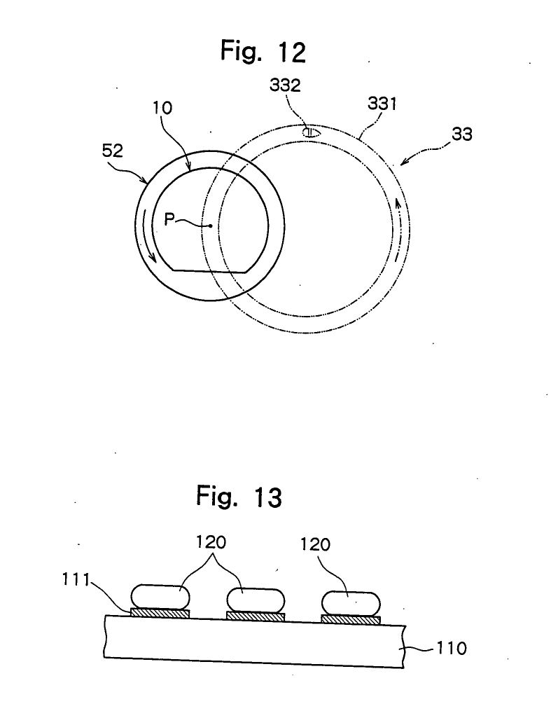

The relationship between the semiconductor wafer 10 held on the chuck table 52 and the cutting tool 33 will be described with reference to FIG. 12.

The semiconductor wafer 10 is located at a position where the cutting blade 332 of the cutting tool 33 passes the center P thereof. The chuck table 52, that is, the semiconductor wafer 10 is rotated in the direction indicated by the arrow at a revolution of 10 rpm or less and simultaneously, the cutting tool 33 is caused to rotate in the direction indicated by the arrow at a revolution of 3,000 rpm or more. Namely, the semiconductor wafer 10 and the cutting tool 33 are rotated in the same direction. By the rotation of the semiconductor wafer 10 and the rotation of the cutting tool 33, the top end portions of the plurality of stud bumps (electrodes) 120 formed on the front surfaces of the semiconductor chips 110 of the semiconductor wafer 10 are cut away to make the stud bumps 120 uniform in height as shown in FIG. 13.

When the cutting tool 36 shown in FIG. 6 is used as the cutting tool, the chuck table 52 is rotated and is moved a distance a little longer than the radius of the semiconductor wafer 10 in the directions shown by the arrows 23a and 23b, because the cutting tool 36 is fixed.

At the time of the above processing, ionized air is ejected toward the semiconductor wafer 10 under processing from the nozzle 14 installed in the side of the processing area 25. By ejecting ionized air toward the semiconductor wafer 10 under processing, static electricity generated at the time of processing can be removed and further, a cooling effect is obtained.

After the plurality of bumps (electrodes) 120 formed on the front surfaces of the semiconductor chips 110 of the semiconductor wafer 10 are cut, the cutting unit 3 is moved up, and the revolution of the rotary spindle 322 and the revolution of the chuck table 52 are suspended. Thereafter, the chuck table 52 is moved in the direction shown by the arrow 23b in FIG. 1 to be positioned in the workpiece take-in/take-out area 24 and the suction-holding of the cut semiconductor wafer 10 on the chuck table 52 is canceled. The semiconductor wafer 10 whose suction-holding has been cancelled is carried to the cleaning means 9 by the workpiece take-out means 13. The semiconductor wafer 10 carried to the cleaning means 9 is cleaned. The semiconductor wafer 10 cleaned by the cleaning means 9 is stored at a predetermined position of the second cassette 7 by the workpiece conveying means 11.

Since in the processing machine constituted according to the present invention as described above the end portions of the electrodes projecting from the front surface of the plate-like workpiece are cut away, the electrodes can be made uniform in height without causing a short circuit.

We claim:

1. A machine for processing electrodes formed on a plate-like workpiece to make the electrodes projecting from the front surface of the plate-like workpiece uniform in height, comprising:
a chuck table having a placing surface for placing the plate-like workpiece, which can be moved between a workpiece take-in/take-out area and a processing area;
a chuck table moving unit for moving the chuck table between the workpiece take-in/take-out area and the processing area;
a cutting unit having a cutting tool for cutting a plurality of electrodes projecting from the front surface of the plate-like workpiece arranged in the processing area and held on the chuck table to make them uniform in height;
a cutting unit feed mechanism for moving the cutting unit in a direction perpendicular to the placing surface of the chuck table;
a take-in means for carrying the plate-like workpiece before processing to the chuck table positioned in the workpiece take-in/take-out area; and
a take-out means for taking out the plate-like workpiece after processing held on the chuck table positioned in the workpiece take-in/take-out area.

2. The machine for processing electrodes formed on a plate-like workpiece according to claim 1, wherein the machine comprises a cassette placing portion for placing a cassette storing a plurality of plate-like workpieces, a workpiece conveying means for taking out the plate-like workpiece before processing from a cassette placed on the cassette placing portion, and a workpiece temporary storage portion for temporarily storing the plate-like workpiece carried by the workpiece conveying means, and the plate-like workpiece carried to the workpiece temporary storage portion is conveyed onto the chuck table positioned in the workpiece take-in/take-out area by the take-in means.

3. The machine for processing electrodes formed on a plate-like workpiece according to claim 2, wherein the machine comprises a cleaning means for cleaning the plate-like workpiece after processing, the plate-like workpiece after processing held on the chuck table positioned in the workpiece take-in/take-out area is carried to the cleaning means by the take-out means, and the plate-like workpiece after processing cleaned by the cleaning means is stored in a cassette placed on the cassette placing portion by the workpiece conveying means.

4. The machine for processing electrodes formed on a plate-like workpiece according to claim 1, wherein the machine comprises a processing fluid supply means for supplying a processing fluid toward the plate-like workpiece held on the chuck table in the processing area.

5. The machine for processing electrodes formed on a plate-like workpiece according to claim 4, wherein the processing fluid supply means supplies ionized air.
